(19) United States
(12) Patent Application Publication
(10) Pub. No.: US 2024/0086169 A1
(43) Pub. Date: Mar. 14, 2024

(54) VIDEO SECURITY SYSTEM CONFIGURED FOR SIMPLIFIED CLUSTER JOIN AND METHOD THEREFOR

(71) Applicant: MOTOROLA SOLUTIONS, INC., CHICAGO, IL (US)

(72) Inventors: PAUL D CHARLES, FRESNO, CA (US); SHAUN MARLATT, NORTH VANCOUVER (US); THANH HO, VANCOUVER (CA); ARUN KUMAR RADHAKRISHNA PILLAI, WINDSOR, CO (US); MICHAEL JAMESON, FRESNO, CA (US)

(21) Appl. No.: 17/931,275

(22) Filed: Sep. 12, 2022

(51) Int. Cl. G06F 8/65; H04L 12/10; H04L 41/082; H04N 21/241; H04N 21/63

(52) U.S. Cl. CPC G06F 8/65; H04L 12/10; H04L 41/082; H04N 21/241; H04N 21/632

(57) ABSTRACT

A video security system configured for simplified cluster join is disclosed. The video security system includes a video management server device that internally includes at least one non-volatile storage medium initially storing incomplete portions of first and second computer readable instructions that entirely define server components that provide first and second operational supports for first and second video cameras. The video management server device is configured to communicate with the first and second video cameras over at least one local area network path. The video management server device is also configured to communicate with a package sourcing entity to transmit information about the incomplete portions to the package sourcing entity. The video management server device is also configured to automatically receive, from the package sourcing entity, an upgrade package that is tailored to include remainder portions of the first and second computer readable instructions without the incomplete portions

### BACKGROUND

In a conventional Video Management System (VMS) along with the respective security environment, upgrades can be complex and time consuming to manage (especially when the upgrades involve larger scale security systems with many devices). Although parts of upgrading may be automated to reduce some human involvement when upgrades are applied, innovative consideration has been lacking in terms of how upgrading might be done in an intelligent manner with consideration for the various clusters and hierarchical levels that are defined within the video security system and that exist across an entirety of a defined network.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

Some reference numerals are repeated in the figures with different subscript numbering to permit differentiation when a similar or analogous element is shown two or more times in a same figure. In such cases, a specific element being referenced in the specification may be denoted by the reference numeral along with its subscript. By contrast, when those elements are referred to generically, merely the reference numeral is referenced in the specification (i.e. without any subscript).

FIG. 1 is a block diagram of a video security system in accordance with example embodiments.

FIG. 2 is a flow chart illustrating a method in accordance with an example embodiment.

FIG. 3 is a diagram depicting more details of a computer terminal included in the video security system of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

According to one example embodiment, there is provided a network that includes a cluster of nodes. The cluster of nodes includes a plurality of operatively-established video cameras including a first video camera and a second video camera. The first video camera is configured to obtain respective first operational support from a first plurality of server components defined entirely by first computer readable instructions. The second video camera is configured to obtain respective second operational support from a second plurality of server components defined entirely by second computer readable instructions different than the first computer readable instructions. The cluster of nodes also includes a video management server device that is an incomer to the cluster. The video management server device internally includes at least one non-volatile storage medium initially storing incomplete portions of the first and second computer readable instructions. The video management server device is configured to communicate with the first and second video cameras over at least one local area network path. The video management server device is also configured to communicate with a package sourcing entity to transmit information about the incomplete portions to the package sourcing entity, and also to automatically receive, from the package sourcing entity, an upgrade package that is tailored to include remainder portions of the first and second computer readable instructions without the incomplete portions. The video management server device is also configured to carry out an upgrade required to enable the video management server device to provide the first and second operational supports by deploying the received upgrade package within the video management server device.

According to another example embodiment, there is provided a method carried out in a network that includes a cluster of nodes. The cluster of nodes including a plurality of operatively-established video cameras including a first video camera and a second video camera. The method includes adding a video management server device as an incomer to the cluster. The video management server device internally includes at least one non-volatile storage medium initially storing incomplete portions of first and second computer readable instructions. The first computer readable instructions entirely define a first plurality of server components that provide first operational support for the first video camera. The second computer readable instructions, different than the first computer readable instructions, entirely define a second plurality of server components that provide second operational support for the second video camera. After adding the video management server device to the cluster, the video management server device is operated to communicate with the first and second video cameras over at least one local area network path. The video management server device is also operated to communicate with a package sourcing entity to transmit information about the incomplete portions to the package sourcing entity, and automatically receive, from the package sourcing entity, an upgrade package that is tailored to include remainder portions of the first and second computer readable instructions without the incomplete portions. The video management server device is also operated to carry out an upgrade required to enable the video management server device to provide the first and second operational supports by deploying the received upgrade package within the video management server device.

Each of the above-mentioned embodiments will be discussed in more detail below, starting with example system and device architectures of the system in which the embodiments may be practiced, followed by an illustration of processing blocks for achieving an improved technical method, system and computer program product for simplified cluster join. Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

The term “cluster” as used herein is understood to mean a group of two or more network-addressable devices selectively assigned to work together in some functional and operational manner.

The term “video management server device” as used herein is understood to mean a self-contained server device having the primary functionality of carrying out video management and storage.

Further advantages and features consistent with this disclosure will be set forth in the following detailed description, with reference to the figures.

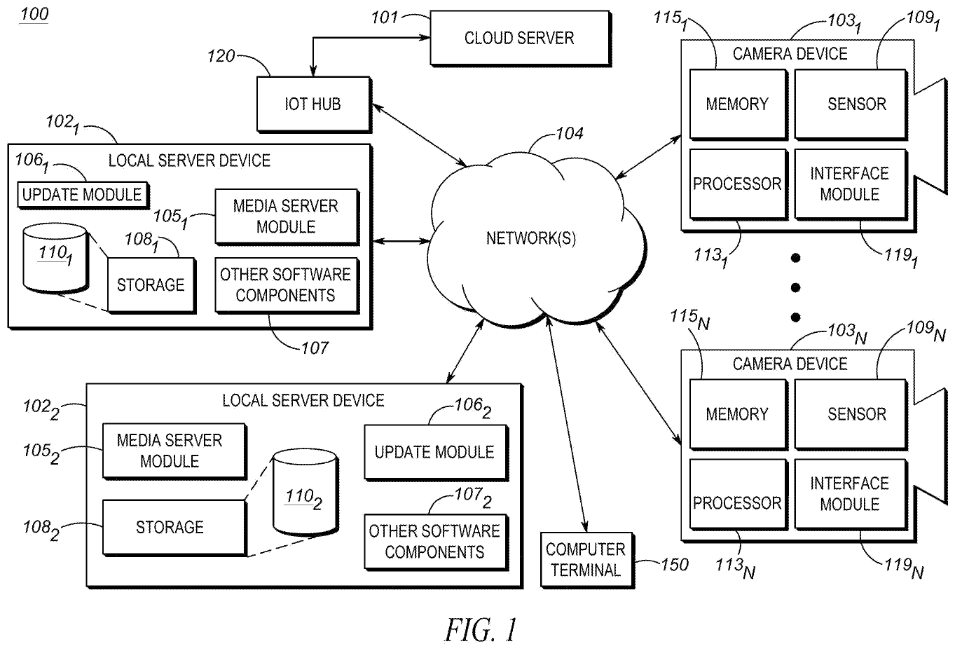

Referring now to the drawings, and in particular FIG. 1 which is a block diagram of an example video security system 100 within which methods in accordance with example embodiments can be carried out. Included within the illustrated video security system 100 are a computer terminal 150, a cloud server 101, a first local server device 102₁, a second local server device 102₂, and camera devices 103₁-103ₙ. In some example embodiments, each of the first and second server devices 102₁ and 102₂ has all of its respective physical components housed in a single dedicated enclosure (although two server devices are shown in FIG. 1, it will be noted that this is merely for convenience of illustration and any suitable number of server devices 102 is contemplated). In some example embodiments, either or both of the first and second server devices 102₁ and 102₂ includes one or more Power-over-Ethernet (PoE) ports configured to pass electric power along with data on twisted-pair Ethernet cabling to one or more of the camera devices 103₁-103ₙ. In some example embodiments, either or both of the first and second server devices 102₁ and 102₂ is one of a Network Video Recorder (NVR) and a Digital Video Recorder (DVR). As will be appreciated by those skilled in the art, both NVRs and DVRs are devices that are responsible for video recording within a video security system. One difference between an NVR and a DVR is how each processes video data. In a DVR system, the video data is processed at the recorder. Conversely, in the NVR system the video data is encoded and processed at the separately housed camera device, and the camera device streams this to the NVR recorder which provides for storage and remote viewing. In some non-limiting examples, the DVR only allows camera devices to be connected to it by way of direct cable connections (this is not illustrated in FIG. 1). In some non-limiting examples, the NVR may not have such a connection requirement, instead only requiring that each camera device be connected to a same network so that they can communicate with each other over that same network (i.e. consistent with what is illustrated in FIG. 1).

As previously mentioned, the video security system 100 includes the cloud server 101. Also shown in FIG. 1 is an Internet-of-things hub 120 (“IOT hub”). In at least some example embodiments, the IOT hub 120 is a cloud-hosted, managed service that bi-directionally connects the cloud server 101 to the network(s) 104 (and then in turn the devices of the video security system 100). The IOT hub 120 may, for example, comprise part of the Microsoft™ Azure™ cloud computing platform, and the cloud server 101 may accordingly be cloud-hosted using the Microsoft™ Azure™ platform.

In the illustrated example embodiment of FIG. 1, each of the first and second server devices 102₁ and 102₂ communicates with one or more of the camera devices 103₁-103ₙ through one or more network(s) 104. The network(s) 104 can include, for example, one or more private networks coupled together by network switches or other communication elements. The network(s) could be of the form of, for example, client-server networks, peer-to-peer networks, etc. Data connections between the illustrated devices can be any of suitable known arrangements for accessing a data communications network, such as, for example, Ethernet, dedicated lease line service, or other known access techniques (for example, radio frequency (RF) links). In the illustrated example embodiment, the first and second server devices 102₁ and 102₂ and the camera devices 103₁-103ₙ are all within the same Local Area Network (LAN).

Referring once again to FIG. 1, each of the first and second server devices 102₁ and 102₂ includes various software components for carrying out functions of the respective server device. For example, the first and second server devices 102₁ and 102₂ include media server modules 105₁ and 105₂ respectively. The media server module 105 handles client requests related to storage and retrieval of security video taken by the camera devices 103₁-103ₙ in the video security system 100. In some examples, the media server module 105 may carry out other functions in relation to other forms of media communicated to user devices/terminals from the respective server device 102 (for example, facilitating the delivery of live or recorded video to a VMS application to be viewed on a display of some communicatively connected user device/terminal). Each of the first and second server devices 102₁ and 102₂ also includes a respective update module 106 for carrying out updates and upgrades that occur within the server device. The first and second server devices 102₁ and 102₂ also include a number of other software components (identified in FIG. 1 by way of reference numerals 107₁ and 107₂ respectively). These other software components will vary depending on the requirements of the first and second server devices 102₁ and 102₂ within the overall system. As just one example, the other software components 107 might include special test and debugging software. As another example, the other software components 107 might include video analytics module(s) which can include, in some examples, any suitable one of known commercially available software that carry out computer vision related functions as understood by a person of skill in the art.

The first and second server devices 102₁ and 102₂ include storage device(s) 108₁ and 108₂ respectively. The illustrated storage device(s) 108₁ and 108₂ include database(s) 110₁ and 110₂ respectively, each of which may facilitate the organized storing of recorded security video in accordance with example embodiments. In some examples, the database(s) 110 may also contain metadata related to, for instance, the recorded video (and/or images) storable within one or more storages. The database(s) 110 may also contain other types of metadata besides video metadata. Examples of metadata other than video/image metadata, that may be stored in the database(s) 110, include audio metadata, Global Positioning System (GPS) location metadata, etcetera.

The illustrated video security system 100 also includes a plurality of camera devices 103₁-103ₙ being operable to capture a plurality of images and produce image data representing the plurality of captured images. The camera device 103 is an image capturing device and includes security video cameras. Furthermore, it will be understood that the video security system 100 includes any suitable number of camera devices (i.e. n is any suitable integer greater than one).

The camera device 103 includes an image sensor 109 for capturing a plurality of images. The camera device 103 may be a digital camera and the image sensor 109 may output captured light as a digital data. For example, the image sensor 109 may be a CMOS, NMOS, or Charge-Couple Device (CCD). In some embodiments, the camera device 103 may be an analog camera connected to an encoder. The illustrated camera device 103 may be a 2D camera; however use of a structured light 3D camera, a time-of-flight 3D camera, a 3D Light Detection and Ranging (LiDAR) device, a stereo camera, or any other suitable type of camera within the video security system 100 is contemplated.

The image sensor 109 may be operable to capture light in one or more frequency ranges. For example, the image sensor 109 may be operable to capture light in a range that substantially corresponds to the visible light frequency range. In other examples, the image sensor 109 may be operable to capture light outside the visible light range, such as in the infrared and/or ultraviolet range. In other examples, the camera device 103 may have similarities to a “multi-sensor” type of camera, such that the camera device 103 includes pairs of two or more sensors that are operable to capture light in different and/or same frequency ranges.

The camera device 103 may be a dedicated camera. It will be understood that a dedicated camera herein refers to a camera whose principal features is to capture images or video. In some example embodiments, the dedicated camera may perform functions associated with the captured images or video, such as but not limited to processing the image data produced by it or by another camera. For example, the dedicated camera may be a security camera, such as any one of a pan-tilt-zoom camera, dome camera, in-ceiling camera, box camera, and bullet camera.

Additionally, or alternatively, the camera device 103 may include an embedded camera. For example, the embedded camera may be a camera found on a drone device, physical access control device, etcetera.

The camera device 103 includes one or more processors 113, one or more interface modules 119, and one or more memory devices 115 coupled to the processors and one or more network interfaces. Regarding the interface module 119, this may include, for example, a network interface card, communication ports, and other components that may facilitate inter-device communications.

Regarding the memory device 115 within the camera device 103, this can include a local memory (such as, for example, a random access memory and a cache memory) employed during execution of program instructions. Regarding the processor 113, this executes computer program instructions (such as, for example, an operating system and/or software programs), which can be stored in the memory device 115.

In various embodiments the processor 113 may be implemented by any suitable processing circuit having one or more circuit units, including a digital signal processor (DSP), graphics processing unit (GPU) embedded processor, a visual processing unit or a vison processing unit (operating optionally in combination with an artificial intelligence image signal processor), etcetera, and any suitable combination thereof operating independently or in parallel, including possibly operating redundantly. Such processing circuit may be implemented by one or more integrated circuits (IC), including being implemented by a monolithic integrated circuit (MIC), an Application Specific Integrated Circuit (ASIC), a Field Programmable Gate Array (FPGA), etc. or any suitable combination thereof. Additionally or alternatively, such processing circuit may be implemented as a programmable logic controller (PLC), for example. The processor may include circuitry for storing memory, such as digital data, and may comprise the memory circuit or be in wired communication with the memory circuit, for example. A system on a chip (SOC) implementation is also common, where a plurality of the components of the camera device 103, including the processor 113, may be combined together on one semiconductor chip. For example, the processor 113, the memory device 115 and possibly other component(s) of the camera device 103 may be implemented within a SOC. Furthermore, when implemented in this way, a general purpose processor and one or more of a GPU or VPU, and a DSP may be implemented together within the SOC.

In various example embodiments, the memory device 115 coupled to the processor 113 is operable to store data and computer program instructions. The memory device 115 may be implemented as Read-Only Memory (ROM), Programmable Read-Only Memory (PROM), Erasable Programmable Read-Only Memory (EPROM), Electrically Erasable Programmable Read-Only Memory (EEPROM), flash memory, one or more flash drives, universal serial bus (USB) connected memory units, magnetic storage, optical storage, magneto-optical storage, etc. or any combination thereof, for example. The memory device 115 may be operable to store in memory (including store in volatile memory, non-volatile memory, dynamic memory, etc. or any combination thereof).

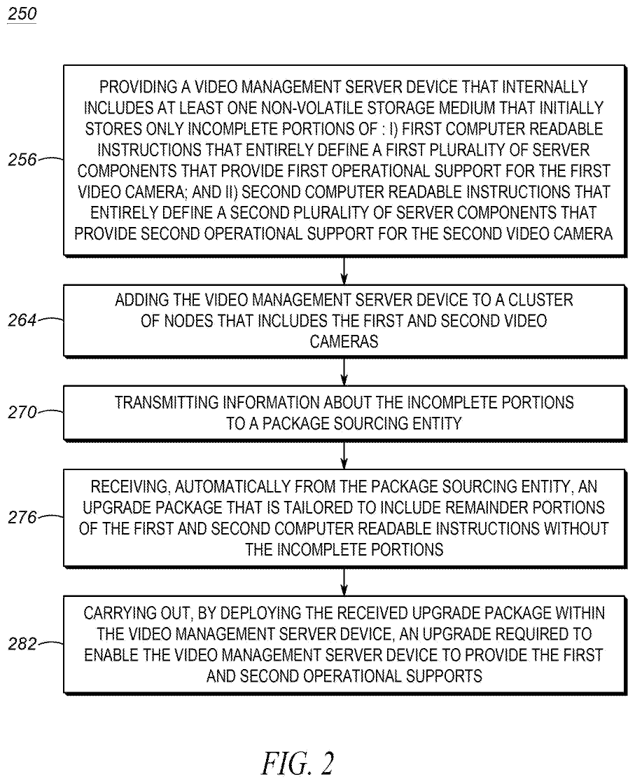

Reference is now made to FIG. 2. In particular, FIG. 2 is a flow chart illustrating a method 250 in accordance with an example embodiment, which in some examples is carried out within the video security system 100.

The illustrated method 250 firstly includes providing (256) a video management server device that internally includes at least one non-volatile storage medium that initially stores only incomplete portions of: i) first computer readable instructions that entirely define a first plurality of server components that provide first operational support for the first video camera; and ii) second computer readable instructions, different than the first computer readable instructions, that entirely define a second plurality of server components that provide second operational support for the second video camera. For example, the above-mentioned first and second computer readable instructions may be stored on the storage 108₂ of the second local server device 102₂ (FIG. 1). (It will be understood that drawing reference to the second local server device 102₂ is for convenience of illustration, and that the method 250 may alternatively be practiced in relation to any suitable video management server device.)

Next the method 250 includes adding (264) the video management server device to a cluster of nodes that includes the first and second video cameras. For example, the camera devices 103₁-103₂ (or some other grouping of the camera devices 103₁-103ₙ) may be included in a cluster, and the second local server device 102₂ may be an incomer to the cluster (i.e. an incomer device is not an operatively-established device, like one of the camera devices 103₁-103₂ would be considered to be). Also, an incomer device may have only, or mostly only, the default software and firmware that was installed on it at the factory (or other vendor facility from which the device was acquired).

In some examples, the second local server device 102₂ may be assuming part of a server load previously assigned to a different server device (for instance, the first local server device 102₁). In other examples, the second local server device 102₂ may entirely replacing an older server device that was previously handling a server load for some defined cluster of camera devices.

Next the method 250 includes transmitting (270) information about the incomplete portions to the package sourcing entity. Regarding the package source entity, this may be, for example: i) the cloud server 101; ii) some trusted third-party server where communications are carried out through one or more secure mechanisms; or iii) even some other addressable device within the same LAN.

Next the method 250 includes receiving (276), automatically from the package sourcing entity, an upgrade package that is tailored to include remainder portions of the first and second computer readable instructions without the incomplete portions. In other words, instead of just outputting an all-purpose upgrade package containing software/firmware parts not needed by the receiving device, the upgrade package is selectively generated to provide only the needed portions not already stored at the receiving device.

Next the method 250 includes carrying out (282), by deploying the received upgrade package within the video management server device, an upgrade required to enable the video management server device to provide the first and second operational supports. For example, the second local server device 102₂ may receive, via the network(s) 104, the upgrade package from the cloud server 101 (or some other suitable package sourcing entity). Once received, the second local server device 102₂ may upgrade itself (facilitated by, for example, the update module 106₂) to provide camera devices of its respective cluster with their respective operational supports.

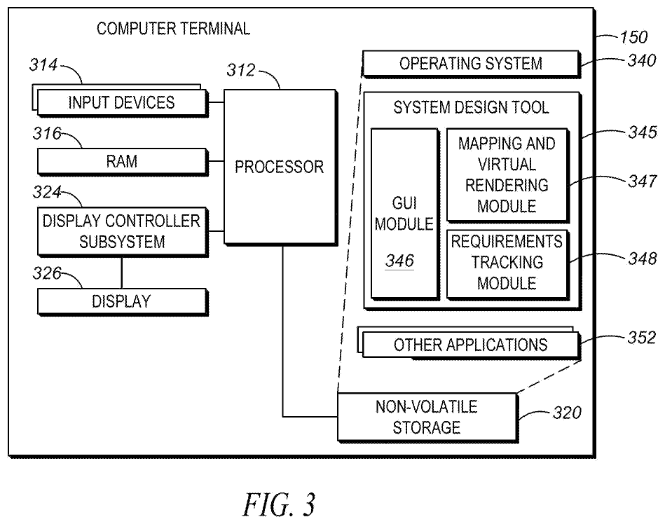

Reference is now made to FIG. 3, which is a diagram depicting more details of the computer terminal 150 included in the video security system 100 of FIG. 1 (although only one terminal is shown in FIG. 1, it will be noted that this is merely for convenience of illustration and any suitable number of computer terminals 150 is contemplated).

The computer terminal 150 includes at least one processor 312 that controls the overall operation of the computer terminal. The processor 312 interacts with various subsystems such as, for example, input devices 314 (such as a selected one or more of a keyboard, mouse, touch pad, roller ball and voice control means, for example), random access memory (RAM) 316, non-volatile storage 320, display controller subsystem 324 and other subsystems. The display controller subsystem 324 interacts with display screen 326 and it renders graphics and/or text upon the display screen 326.

Still with reference to the computer terminal 150 of the video security system 100, operating system 340 and various software applications used by the processor 312 are stored in the non-volatile storage 320. The non-volatile storage 320 is, for example, one or more hard disks, solid state drives, or some other suitable form of computer readable medium that retains recorded information after the computer terminal 150 is turned off. Regarding the operating system 340, this includes software that manages computer hardware and software resources of the computer terminal 150 and provides common services for computer programs. Also, those skilled in the art will appreciate that the operating system 340, system design tool 345, and other applications 352, or parts thereof, may be temporarily loaded into a volatile store such as the RAM 316. The processor 312, in addition to its operating system functions, can enable execution of the various software applications on the computer terminal 150.

Regarding the system design tool 345, this is software for helping a user in designing (and design updating) a system of security devices (for example, designing functions relating to selecting appropriate security cameras, camera lenses, video storages appliances, etc. to be deployed within one or more geographic areas). The illustrated system design tool 345 includes a Graphical User Interface (GUI) module 346. For example, the GUI module generates a GUI to be provided on the display screen 326 within which a user may make virtual changes and modifications to camera devices (or other types of sensor devices, network-addressable security devices, etcetera) within a virtual version of, for example, the actual/physically tangible video security system 100. Such a GUI may also be configured to allow a user to selectively view one or more virtual security cameras within a visual map of a geographical area.

The system design tool 345 also includes a mapping and virtual rendering module 347 which, in combination with the GUI module 346, may operate to, for example, identify and/or simulate: i) the two-dimensional or three-dimensional placement of virtual versions of the camera devices 103₁-103ₙ and their corresponding performance; and ii) assignments (including cluster assignments) of virtual versions of local server devices (including a virtual version of the second local server device 102₂) and simulating the corresponding performance. Furthermore, the system design tool 345 may permit graphical simulation in two-dimensions or three-dimensions, and also show how adding an upgraded security camera and/or a local server device can impact performance. For instance, the user can operate the input devices 314 in providing user input in connection with assessing performance (within a graphical user interface) both prior to and after simulated changes and modifications within a security system (such as, for example, the video security system 100).

The illustrated system design tool 345 also includes a requirements tracking module 348. Amongst other contemplated functions, the requirements tracking module 348 manages and stores firmware and software requirement profiles corresponding to virtual devices included within an updated virtual version of an actual security system. These requirement profiles may be collectively stored in, for example, one or more files, and the one or more files can reside on for instance, the non-volatile storage 320, storage in the cloud server 101, etcetera. It is also contemplated that these one or more files may detail, for each cluster in the changed/modified system design, a design requirements specification. Furthermore, this design requirements specification may be employed to carry of a comparison in connection with the previous described method 250 (FIG. 2). More specifically, the transmitted information (i.e. previously described in connection with the action 270 of the method 250) may be compared against the design requirements specification to determine what is to be included in the upgrade package (and conversely what is not to be included in the upgrade package).

As should be apparent from this detailed description, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etcetera, and cannot carry out specified software and/or firmware upgrades in a video security system, among other features and functions set forth herein).

In the foregoing specification, specific embodiments have been described. However, one of ordinary skill in the art appreciates that various modifications and changes can be made without departing from the scope of the invention as set forth in the claims below. For example, instead of the various software applications (like, for instance, the system design tool 345) being installed on the local storage for the computing apparatus that runs the application(s), the software may instead be web/browser-based software served to the computing apparatus via network(s).

Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending in the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through an intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A network comprising:
a cluster of nodes including:
a plurality of operatively-established video cameras including a first video camera and a second video camera, the first video camera being configured to obtain respective first operational support from a first plurality of server components defined entirely by first computer readable instructions, and the second video camera being configured to obtain respective second operational support from a second plurality of server components defined entirely by second computer readable instructions different than the first computer readable instructions; and
a video management server device that is an incomer to the cluster, the video management server device internally including at least one non-volatile storage medium initially storing incomplete portions of the first and second computer readable instructions, and the video management server device being configured to:
communicate with the first and second video cameras over at least one local area network path,
communicate with a package sourcing entity to:
transmit information about the incomplete portions to the package sourcing entity, and
automatically receive, from the package sourcing entity, an upgrade package that is tailored to include remainder portions of the first and second computer readable instructions without the incomplete portions, and
carry out an upgrade required to enable the video management server device to provide the first and second operational supports by deploying the received upgrade package within the video management server device.

2. The network as claimed in claim 1 wherein the video management server device is a Network Video Recorder (NVR) or a Digital Video Recorder (DVR).

3. The network as claimed in claim 2 wherein the plurality of operatively-established video cameras are configured to be powered by respective Power-over-Ethernet (PoE) connections to the video management server device.

4. The network as claimed in claim 1 wherein the package sourcing entity is a remote cloud server, and the video management server device is communicatively coupled to the remote cloud server over a wide area network.

5. Apparatus comprising:
the network as claimed in claim 1; and
a system remote from the network that includes a computer readable medium storing a design requirements specification for the cluster of nodes, and the system being communicatively coupled to the network via a wide area network, and
wherein the system is configured to receive, from the video management server device, the transmitted information for carrying out a comparison thereafter against the design requirements specification to determine what is to be included in the upgrade package.

6. A method carried out in a network that includes a cluster of nodes, the cluster of nodes including a plurality of operatively-established video cameras including a first video camera and a second video camera, and the method comprising:
adding a video management server device as an incomer to the cluster, the video management server device internally including at least one non-volatile storage medium initially storing incomplete portions of first and second computer readable instructions, wherein the first computer readable instructions entirely define a first plurality of server components that provide first operational support for the first video camera, and wherein the second computer readable instructions, different than the first computer readable instructions, entirely define a second plurality of server components that provide second operational support for the second video camera; and
after adding the video management server device to the cluster, operating the video management server device to:
communicate with the first and second video cameras over at least one local area network path,
communicate with a package sourcing entity to:
transmit information about the incomplete portions to the package sourcing entity, and
automatically receive, from the package sourcing entity, an upgrade package that is tailored to include remainder portions of the first and second computer readable instructions without the incomplete portions, and
carry out an upgrade required to enable the video management server device to provide the first and second operational supports by deploying the received upgrade package within the video management server device.

7. The method as claimed in claim 6 wherein the video management server device is a Network Video Recorder (NVR) or a Digital Video Recorder (DVR).

8. The method as claimed in claim 7 wherein the plurality of operatively-established video cameras are powered by respective Power-over-Ethernet (PoE) connections to the video management server device.

9. The method as claimed in claim 6 wherein the package sourcing entity is a remote cloud server, and the video management server device is communicatively coupled to the remote cloud server over a wide area network.

10. The method as claimed in claim 6 further comprising:
storing a design requirements specification for the cluster of nodes on a computer readable medium; and
comparing the transmitted information against the design requirements specification to determine what is to be included in the upgrade package.

11. The method as claimed in claim 10 wherein the computer readable medium resides on a system that is communicatively coupled to the network via a wide area network, and wherein the system carries out the comparing after having received the transmitted information from the video management server device.
